(19) United States
(12) Patent Application Publication
(10) Pub. No.: US 2024/0105380 A1
(43) Pub. Date: Mar. 28, 2024

(54) COIL COMPONENT

(71) Applicant: Murata Manufacturing Co., Ltd., Kyoto-fu (JP)

(72) Inventors: Kozo SATO, Nagaokakyo-shi (JP); Yuichi OHBA, Nagaokakyo-shi (JP)

(73) Assignee: Murata Manufacturing Co., Ltd., Kyoto-fu (JP)

(21) Appl. No.: 18/365,855

(22) Filed: Aug. 4, 2023

(30) Foreign Application Priority Data
Sep. 27, 2022 (JP) 2022-154110

(51) Int. Cl. H01F 27/29; H01F 27/255

(52) U.S. Cl. CPC H01F 27/292; H01F 27/255

(57) ABSTRACT

A coil component having improved magnetic characteristics. The coil component includes a body having a substantially hexahedral shape and including a winding portion formed by winding a conductive wire based on a winding axis and a magnetic body portion; and paired metal terminals having joint portions to which first and second ends of the conductive wire are electrically connected. Each of the paired metal terminals extends outside an outer surface of the body parallel to the winding axis. Of four quadrants separated from one another by imaginary coordinate axes that are orthogonal to one another with the center of the body as the origin in plan view in the winding axis direction, more than half the area of one of the joint portions is disposed in a quadrant not adjacent to the quadrant in which more than half the area of the other joint portion is disposed.

### CROSS-REFERENCE TO RELATED APPLICATION

This application claims benefit of priority to Japanese Patent Application No. 2022-154110, filed Sep. 27, 2022, the entire content of which is incorporated herein by reference.

### BACKGROUND

### Technical Field

The present disclosure relates to a coil component.

### Background Art

Japanese Unexamined Patent Application Publication No. 2015-035633 discloses a coil component including a magnetic core containing a magnetic material, a coil embedded in the magnetic core and formed by winding a conductive wire, and terminals to which extended wires of both end portions of the coil are electrically connected. The paired extended wires are extended toward one side face of the magnetic core beside which no metal terminal is disposed when viewed in the winding axis direction of the coil, and each of the extended wires is electrically connected to the corresponding terminal (refer to FIGS. 7 to 9 of Japanese Unexamined Patent Application Publication No. 2015-035633).

### SUMMARY

The inventors of the present application have noticed that such an existing coil component has a problem to overcome and have found the need to address the problem. Specifically, the inventors of the present application have found the following problem therein.

In the coil component disclosed in Japanese Unexamined Patent Application Publication No. 2015-035633, the electrically connecting positions of extended wires 200 and terminals 210 are both closer to one side face when viewed in the winding axis direction of a coil 230 (refer to FIG. 11A). Thus, the coil 230 embedded in a magnetic core 240 is lacking in balance, thereby having a problem of tilting due to stress 220 applied when the coil 230 is embedded in the magnetic core 240 during manufacture of the coil component as FIG. 11B illustrates. An embodiment of covering of the magnetic core 240 that covers the coil 230 is nonuniform due to the tilt of the coil 230, and such nonuniformity affects the magnetic characteristics.

Accordingly, the present disclosure provides a coil component having improved magnetic characteristics.

The inventors of the present disclosure have addressed the above in a new direction. As a result, the inventors of the present disclosure have made the embodiments discussed herein.

A coil component according to the present disclosure includes a body including a winding portion formed by winding a conductive wire based on a winding axis and a magnetic body portion; and paired metal terminals having joint portions to which a first end and a second end of the conductive wire are electrically connected.

Each of the paired metal terminals is extended outside an outer surface of the body parallel to the winding axis.

Of four quadrants separated from one another by imaginary coordinate axes that are orthogonal to one another with the center of the body as the origin in plan view in the winding axis direction, more than half the area of one of the joint portions is disposed in a quadrant not adjacent to the quadrant in which more than half the area of the other joint portion is disposed.

A height difference between the joint portion closer to the first end and the joint portion closer to the second end is less than or equal to the diameter of the conductive wire.

The winding portion formed by winding the conductive wire hardly tilts because, in the coil component of the present disclosure, of the four quadrants separated from one another by the imaginary coordinate axes that are orthogonal to one another with the center of the body as the origin in plan view in the winding axis direction, more than half the area of one of the joint portions is disposed in the quadrant not adjacent to the quadrant in which more than half the area of the other joint portion is disposed, and the height difference between the joint portion closer to the first end and the joint portion closer to the second end is less than or equal to the diameter of the conductive wire. Thus, reduction in degradation of the magnetic characteristics due to the tilt of the winding portion can be achieved.

### BRIEF DESCRIPTION OF THE DRAWINGS

FIG. 1 is a perspective view of a coil component according to the present disclosure;

FIG. 2A is a plan perspective view of the coil component according to the present disclosure, and FIG. 2B is a plan view illustrating a modification of the coil component according to the present disclosure and illustrating the relationship between quadrants and joint portions;

FIG. 3 is a sectional view of the coil component according to the present disclosure taken along line of FIG. 2A;

FIG. 4A is a perspective view of a wound conductive wire, and FIG. 4B is a plan view thereof;

FIG. 5A illustrating the winding of the conductive wire, and FIG. 5B illustrates a modification of the winding of the conductive wire;

FIG. 6 is a perspective view of an embodiment of the wound conductive wire from which a coating of both end portion is removed;

FIG. 7A is a process schematic view illustrating a step of aligning the heights of end portions of the wound conductive wire, and FIG. 7B is a perspective view of an embodiment of the wound conductive wire after the step illustrated in FIG. 7A;

FIG. 8A is a process perspective view of a step of joining the wound conductive wire and a metal terminal, and FIG. 8B is a process plan view thereof;

FIG. 9 is a process schematic view illustrating a step of embedding the wound conductive wire in a magnetic material;

FIG. 10 is a process schematic view illustrating a step of bending the metal terminal protruding from a body; and

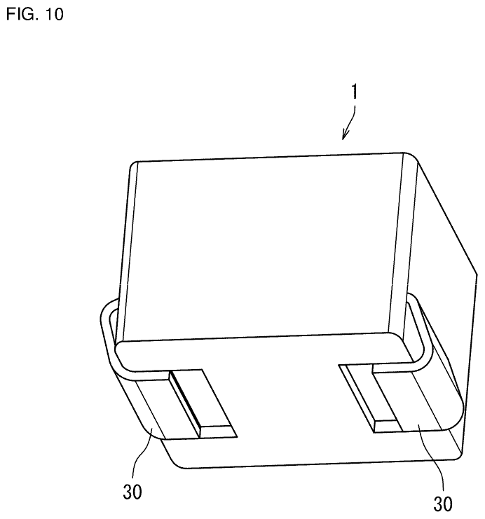

FIG. 11A is a perspective view of an embodiment of a coil component of the related art in which an extended wire and a terminal are connected to one another, and FIG. 11B is a process sectional view illustrating a step of embedding a coil of the coil component of the related art in a magnetic core.

### DETAILED DESCRIPTION

Hereinafter, a coil component of the present disclosure will be described in detail. While the coil component will be described with reference to the drawings as needed, the drawings are merely schematic and illustrative for facilitating understanding of the present disclosure, and, for example, the appearances and dimensional ratios given in the drawings may differ from the appearances and dimensional ratios of the actual constituents. Note that a configuration of the coil component described herein is merely illustrative for facilitating understanding of the disclosure, and the disclosure is not limited to the configuration.

Various numeric ranges referred to in this specification are each intended to include lower limit and upper limit values unless specific terms such as “less than” or “more than/larger than” are given. That is, for example, the numeric range from 1 to 10 may be assumed to include a lower limit value of “1” and an upper limit value of “10”. In addition, terms such as “approximately” and “about” mean that variation of several percent, for example, ±10% may be included.

Description of Coil Component

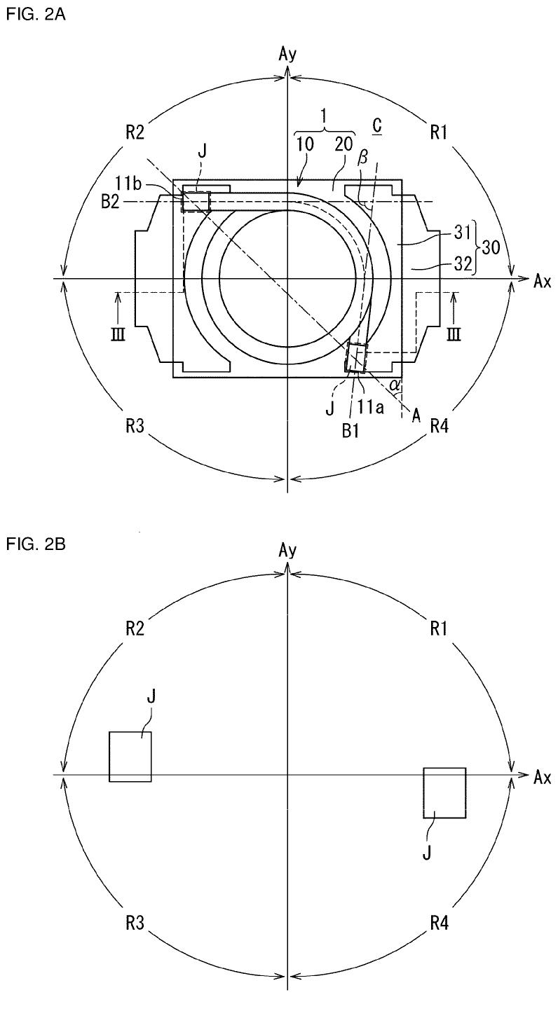

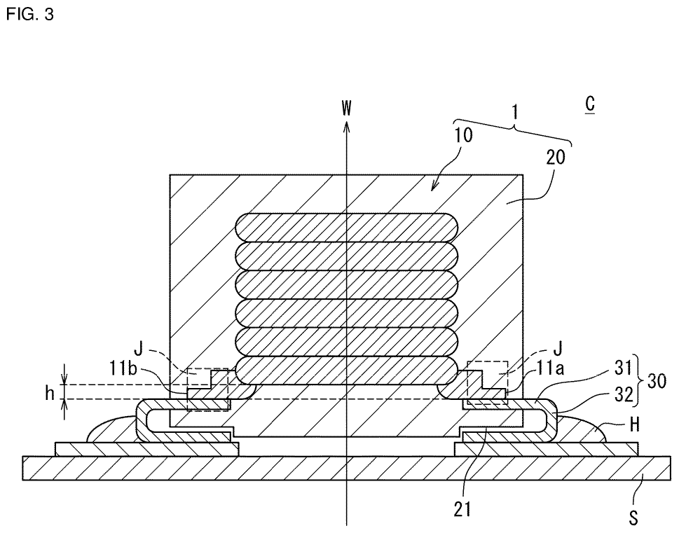

A coil component C of the present disclosure includes: a body 1 including a winding portion 10 formed by winding a conductive wire L based on a winding axis W and a magnetic body portion 20; and paired metal terminals 30 having joint portions J to which a first end 11a and a second end 11b of the conductive wire L are electrically connected. The conductive wire L and the paired joint portions J are positioned in the body 1. Of four quadrants R1 to R4 separated from one another by imaginary coordinate axes Ax and Ay that are orthogonal to one another with the center of the body 1 as the origin in plan view in the winding axis direction, more than half the area of one of the joint portions J is disposed in a quadrant not adjacent to the quadrant in which more than half the area of the other joint portion J is disposed (refer to FIGS. 2A and 2B). A height difference between the joint portion J closer to the first end 11a and the joint portion J closer to the second end 11b is less than or equal to the diameter of the conductive wire L (refer to FIG. 3. Note that FIG. 3 illustrates an embodiment in which there is almost no height difference therebetween).

In the specification, “the imaginary coordinate axes” mean axes that are orthogonal to one another with the center of the body 1 as the origin. Specifically, as FIG. 2A illustrates, the imaginary coordinate axes Ax and Ay are bisectors, of sides constituting the body 1, extending through the center of the body 1. In the specification, “the center of the body” means an intersection point of the imaginary coordinate axes Ax and Ay. In addition, “an approximate center of the body” is not limited to the above-described intersection point and means a region around the intersection point. In one example, “the region around the intersection point” may mean a circular region including the intersection point and having an area of about 10% of the surface area of the body 1 in plan view in the winding axis direction. In the specification, “the quadrants” mean four regions separated from one another by two straight lines (the imaginary coordinate axes Ax and Ay) that are orthogonal to one another on a plane. The first quadrant R1 is a region defined by the imaginary coordinate axis Ax representing a positive range of coordinates and the imaginary coordinate axis Ay representing a negative range of coordinates, the second quadrant R2 is a region defined by the imaginary coordinate axis Ax representing a negative range of coordinates and the imaginary coordinate axis Ay representing a positive range of coordinates, the third quadrant R3 is a region defined by the imaginary coordinate axis Ax representing a negative range of coordinates and the imaginary coordinate axis Ay representing a negative range of coordinates, and the fourth quadrant R4 is a region defined by the imaginary coordinate axis Ax representing a positive range of coordinates and the imaginary coordinate axis Ay representing a negative range of coordinates. In the specification, “the quadrants not adjacent to one another” mean two quadrants that do not share the boundary therebetween. In the specification, “a height difference” means a difference in height in the winding axis direction. In the specification, “the area of the joint portion” means the surface area of the joint portion in plan view in the winding axis direction.

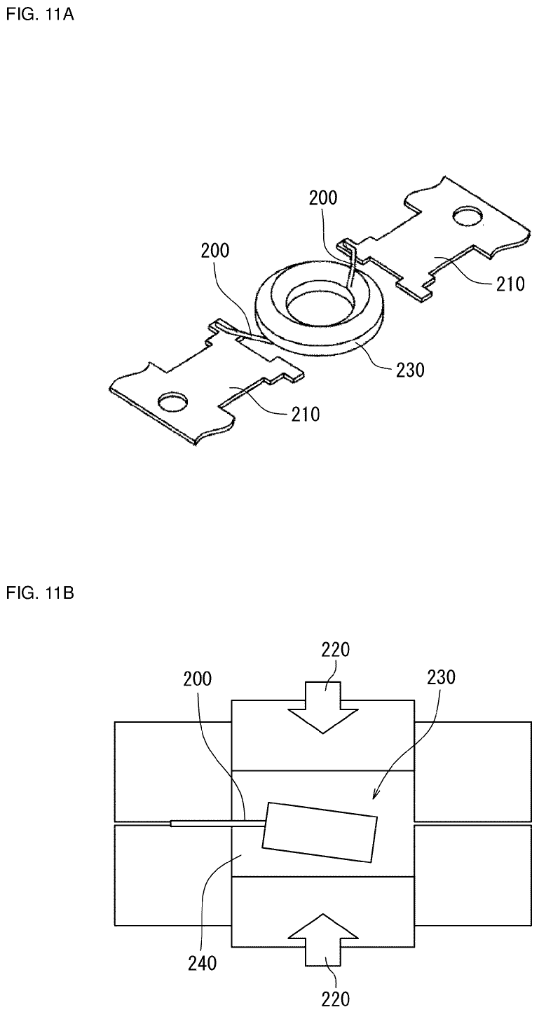

In an embodiment illustrated in FIG. 2A, the joint portion J closer to the first end 11a of the conductive wire L is positioned in the fourth quadrant R4, and the joint portion J closer to the second end 11b of the conductive wire L is positioned in the second quadrant R2. That is, the joint portions J are disposed in the respective quadrants not adjacent to one another. Note that FIG. 2A illustrates the embodiment in which the joint portions J are included in the quadrants; however, instead of such an embodiment, more than half the area of one of the joint portions J may be disposed in a quadrant not adjacent to the quadrant in which more than half the area of the other joint portion J is disposed as FIG. 2B illustrates. Here, the embodiment illustrated in FIG. 2B represents only the relationship between the quadrants R1 to R4 and the joint portions J, and other constituents are omitted. Consequently, the winding portion 10 can be suppressed from tilting during manufacture of the coil component compared with a coil component of the related art (for example, FIGS. 11A and 11B). In addition, with the arrangement of the joint portions in the quadrants not adjacent to one another, the inside diameter of the coil can be increased, and inductance can thus be increased.

Moreover, the height difference between the joint portion J closer to the first end 11a and the joint portion J closer to the second end 11b is less than or equal to the diameter of the conductive wire L, and stress is thereby uniformly applied to the winding portion 10 during manufacture of the coil component. Thus, the winding portion 10 can be suppressed from tilting compared with a coil component of the related art (for example, FIGS. 11A and 11B).

Hereinafter, the configuration of the coil component of the present disclosure will be described in detail. Note that the coil component of the present disclosure is assumed to be a product having a volume of 35 mm³ or more and 1100 mm³ or less (i.e., from 35 mm³ to 1100 mm³), more preferably, 45 mm³ or more and 350 mm³ or less (i.e., from 45 mm³ to 350 mm³).

Body

The body 1 may have a substantially hexahedral shape. In the specification, “the substantially hexahedral shape” refers to a solid shape surrounded by six planes, and the concept thereof includes one having six substantially quadrilateral planes and one having a quadrilateral plane having a curved side or a round corner. In addition, in “the substantially hexahedral shape”, faces thereof facing one another in the winding axis direction of the coil conductor correspond to an “upper face” and a “lower face”, and four faces parallel to the winding axis correspond to “side faces”. Note that the term “parallel” in the specification includes, in addition to perfectly parallel, substantially parallel within a certain error range. The term “orthogonal” in the specification includes, in addition to perfectly orthogonal, substantially orthogonal within a certain error range. The body 1 includes the winding portion 10 formed by winding the conductive wire L and the magnetic body portion 20 covering the winding portion 10.

Winding Portion

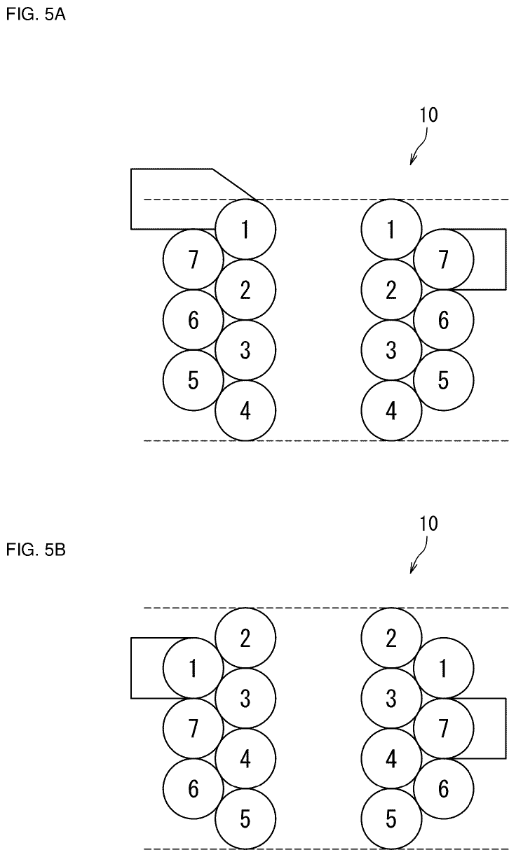

The winding portion 10 may be configured by winding the conductive wire L (for example, a metal wire, preferably a copper wire). In an example illustrated in FIG. 3, the conductive wire L may be wound around the winding axis direction in several turns. Such winding may be any one of a winding, edgewise winding, non-alignment winding, alignment winding, and other winding methods. In other words, the winding portion 10 preferably has, at the center, a space in which the magnetic body portion 20 is disposed. Regarding the winding method of the conductive wire L, which will be described later, a winding start and a winding finish of the conductive wire L are preferably positioned on the outermost side of the winding portion 10 (a so-called, outside-to-outside wound coil; refer to FIG. 5B appropriately) in view of the heights of portions, of the conductive wire L, extended outside the winding portion 10. Note that one of the winding start and the winding finish of the conductive wire L may be positioned on the outermost side of the winding portion 10, and the other may be positioned on the innermost side of the winding portion 10 (a so-called, inside-to-outside wound coil; refer to FIG. 5A appropriately). Alternatively, the winding start and the winding finish of the conductive wire L may be positioned on the innermost side of the winding portion 10 (a so-called, inside-to-inside wound coil).

The winding axis W of the winding portion 10 may be positioned so as to extend through the substantial center of the body 1. With such positioning of the winding axis W, the winding portion 10 can be provided in a symmetrical manner relative to the body 1, and preferred inductance characteristics can thereby be obtained.

The conductive wire L may be a round wire or a rectangular wire in sectional view. Note that, in the specification, “the diameter of the conductive wire” means the diameter of the conductive wire in the case of the round wire and means the length of a short side in the case of the rectangular wire. More specifically, “the diameter of the conductive wire” means, in the case of the round wire, the average of the maximum dimensions of portions of the conductive wire L in the winding axis direction when the winding portion 10 is viewed in section, and means, in the case of the rectangular wire, the average of the maximum dimensions of short sides of portions of the conductive wire L when the winding portion 10 is viewed in section. Note that, in sectional view of the winding portion 10 described above, “the diameter of the conductive wire” may mean the dimension of a short side of the conductive wire L in a section taken along the line connecting the center of each of the paired metal terminals 30 to the winding axis W after the coil component of the present disclosure has been manufactured.

Each of the first end 11a and the second end 11b of the conductive wire L may be extended from the uppermost tier or the lowermost tier of the winding portion 10 respectively. FIG. 3 illustrates one embodiment in which the first end 11a and the second end 11b of the conductive wire L is extended from the lowermost tier of the winding portion 10. While the reason thereof will be detailed in the following section titled “Manufacturing Method of Coil Component”, such an embodiment of winding enables the height positions of the first end 11a and the second end 11b of the conductive wire to be aligned. With the height positions being kept aligned, even when stress exerted in the winding axis direction is applied for forming the body 1, it is possible to reduce a difference between the stress applied to the joint portion J closer to the first end 11a and the stress applied to the joint portion J closer to the second end 11b.

In a preferred embodiment of winding of the conductive wire L, there may be a height difference h, less than or equal to the diameter of the conductive wire L, between the lower surface of the lowermost tier of the winding portion 10 and a joint surface (lower surface) of the first end 11a or the second end 11b of the conductive wire joined to the joint portion J of the metal terminal 30 (refer to FIG. 3). When the height difference h is less than or equal to the diameter of the conductive wire Las described above, the tilt of the winding portion 10 due to the stress applied thereto during manufacture of the coil component can be reduced. Note that FIG. 3 illustrates the embodiment in which there is the height difference h between the lower surface of the lowermost tier of the winding portion 10 and the joint surface of the first end 11a (or the second end 11b) of the conductive wire; however, this example is not the only option. A portion of the conductive wire L may be extended from the uppermost tier of the winding portion 10, and there may be a height difference between the upper surface of the uppermost tier of the winding portion 10 and the joint surface of the first end 11a (or the second end 11b) of the conductive wire. Alternatively, such surfaces may be flush with one another without any height difference h therebetween.

Moreover, in FIG. 3, the second end 11b of the conductive wire L may be positioned on an extension line of the first end 11a of the conductive wire L. However, the present disclosure is not limited to this embodiment, and there may be a height difference, less than or equal to the diameter of the conductive wire L, between the first end 11a and the second end 11b of the conductive wire L. When such a height difference is less than or equal to the diameter of the conductive wire L, the tilt of the winding portion 10 during manufacture of the coil component can be reduced.

The first end 11a and the second end 11b of the conductive wire L are electrically connected to the joint portions J of the paired metal terminals 30, which will be described later. In a preferred embodiment, the first end 11a or the second end 11b of the conductive wire L may have a flat shape. With such a flat shape, the contact area between the first end 11a or the second end 11b and the metal terminal 30 can be increased, and the first end 11a or the second end 11b of the conductive wire L and the metal terminal 30 can thereby be joined to one another firmly. Specifically, the first end 11a or the second end 11b may be flattened to a thickness equal to two-thirds or less of the diameter of the conductive wire L.

The periphery of the conductive wire L may be covered with an insulating material. In this case, the winding portion 10 can be firmly fixed inside the body 1, together with a resin contained in the above-described magnetic body portion 20. Note that an insulating material of the periphery may be removed for electrically connecting the first end 11a and the second end 11b of the conductive wire L to the metal terminals 30.

In a preferred embodiment of the winding portion 10, in plan view in the winding axis direction, an angle β formed by an imaginary straight line B1 (refer to FIG. 2A) connecting an extended portion extended outside the winding portion 10 to the first end 11a of the conductive wire L with an imaginary straight line B2 (refer to FIG. 2A) connecting an extended portion extended outside the winding portion 10 to the second end 11b of the conductive wire L may be an acute angle. In the case of such an acute angle, the joint portions J at which the first end 11a and the second end 11b of the conductive wire L and the metal terminals 30 are joined to one another may be preferably arranged. In addition, the range of the acute angle of 70° or more and less than 90° (i.e., from 70° to less than 90°) is preferable. The range of 75° or more and 85° or less (i.e., from 75° to 85°) is more preferable. Within such ranges, the joint portions J can be arranged optimally.

In the specification, “the portion extended outside the winding portion” means a portion, of the conductive wire L, extended outside the winding portion 10 in plan view and more specifically means the position of a portion of the winding portion 10 outside a tiered part of the conductive wire L in plan view. In the specification, “the imaginary straight line from the portion extended outside the winding portion to the first end (or the second end) of the conductive wire” means an imaginary straight line connecting a point corresponding to “the portion extended outside the winding portion” described above to a point corresponding to the first end 11a (or the second end 11b) of the conductive wire L. When specified in a different point of view, “the imaginary straight line” described above may be a tangent connecting an end portion of the conductive wire L to the outer contour of the winding portion 10.

Magnetic Body Portion

The magnetic body portion 20 may be configured by curing a magnetic material.

Such a magnetic material may contain at least a magnetic raw material particle, a resin, and a solvent. Note that such a solvent may evaporate when the magnetic material is cured.

Magnetic Raw Material Particle

Examples of the magnetic raw material particle may include an Fe-based magnetic metal particle used for the related art, such as a particle of Fe (pure iron) or an Fe alloy. As an example of such an Fe alloy particle, there may be used particles made of one or more magnetic metal materials selected from the group consisting of an alloy containing Fe and Ni, an alloy containing Fe and Co, an alloy containing Fe and Si, an alloy containing Fe, Si, and Cr, an alloy containing Fe, Si, and Al, an alloy containing Fe, Si, B, and Cr, and an alloy containing Fe, P, Cr, Si, B, Nb, and C. Moreover, the surface of the magnetic raw material particle may be insulated. For example, the magnetic raw material particle may have an insulating coating on the surface. Such an insulating coating may be or include, for example, one or more insulating coatings selected from the group consisting of an inorganic glass coating, an organic-inorganic hybrid coating, and an inorganic insulating coating formed through the sol-gel reaction of a metal alkoxide. The magnetic raw material particles may constitute 93% by weight or more and 99% by weight or less (i.e., from 93% by weight to 99% by weight) of the entire magnetic material. More specifically, the magnetic raw material particles may constitute 93% by weight or more and 98% by weight or less (i.e., from 93% by weight to 98% by weight) of the entire magnetic material.

Resin

The resin may contain a functional group contributing to the curing reaction. That is, manufacturing of a magnetic body may be enabled by curing the resin through the curing reaction thereof. More Specifically, the resin before the magnetic body is manufactured is uncured. The term “uncured” in the specification means a state of the resin before the resin is substantially perfectly cured and includes a semi-cured state. The resin may be constituted by, for example, at least one material selected from the group consisting of an epoxy resin, a phenolic resin, a polyester resin, a polyimide resin, a polyolefin resin, and a silicone resin. When an epoxy resin is used for the resin in particular, a magnetic body having high electrically insulating properties and/or high mechanical strength can be obtained. Alternatively, thermoplastic resins such as polyamide-imide, polyphenylene sulfide, and/or a liquid crystal polymer may be used. The curing reaction is preferably produced by heat. That is, the resin is preferably a thermosetting resin. A thermosetting epoxy resin is an example thereof. With such a resin, the curing reaction can be produced by a simple method. The resin may constitute 1.0% by weight or more and 5.6% by weight or less (i.e., from 1.0% by weight to 5.6% by weight) of the entire magnetic material. More preferably, the resin may constitute 2.0% by weight or more and 5.6% by weight or less (i.e., from 2.0% by weight to 5.6% by weight) of the entire magnetic material.

Solvent

The solvent is used for mixing the above-described magnetic raw material particles and resin and is preferably an organic solvent. For example, the solvent may contain any one of aromatic hydrocarbons such as toluene and xylene; ketones such as acetone, methyl ethyl ketone, and methyl isobutyl ketone; alcohols such as methanol, ethanol, and isopropyl alcohol; and glycol ethers such as propylene glycol monomethyl ether and propylene glycol monomethyl ether acetate.

The magnetic body portion 20 whose base is the above-described magnetic material covers the winding portion 10 formed by winding the conductive wire L (refer to FIG. 3). Thus, the magnetic body portion 20 is magnetized, and desired inductance characteristics can thereby be obtained.

A preferred embodiment of the magnetic body portion 20 may have an accommodation portion 21 (refer to FIG. 3) in which a portion of the metal terminal 30 folded to the substrate mounting surface side of the body 1 is accommodated. Specifically, a corner part of the magnetic body portion 20 may be cut out so as to accommodate the metal terminal 30. Such a configuration enables reduction in height of the coil component according to the cutout amount, thereby enabling reduction in product size.

Metal Terminal

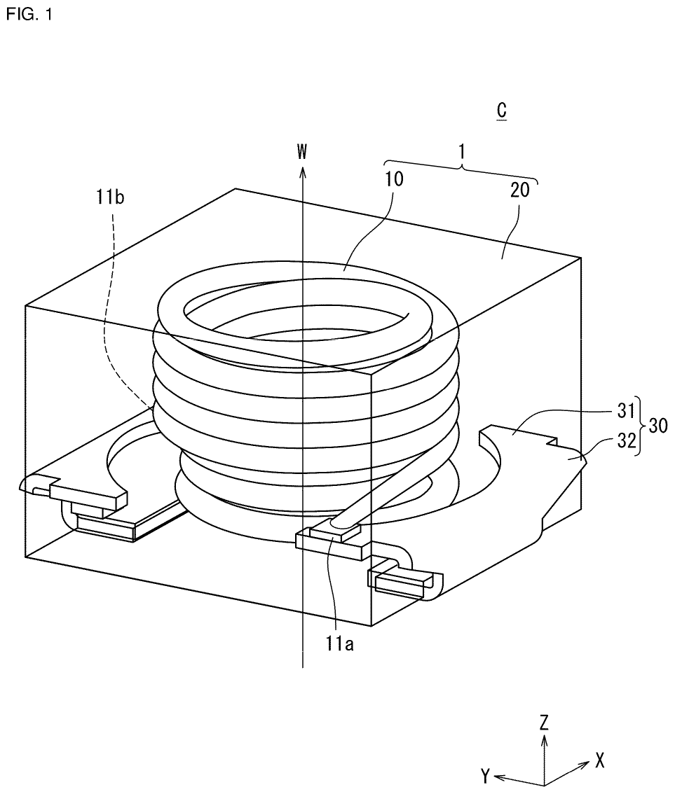

The metal terminal 30 may include an inside portion 31 positioned inside the body 1 and an outside portion 32 exposed outside the body 1 (refer to FIGS. 1 to 3).

The metal terminal 30, with the inside portion 31 thereof, may be electrically connected to a portion of the conductive wire L extended outside the winding portion 10 at the joint portion J. That is, the joint portion J may be disposed inside the body 1. Thus, compared with the case in which such an electrical joining position is outside the body 1, separation of electrical joining between the metal terminal 30 and the conductive wire L is hardly caused.

Regarding the joint portions J of the metal terminals 30, more than half the plane area of one of the joint portions J may be disposed in a quadrant not adjacent to the quadrant in which more than half the plane area of the other joint portion J is disposed. Specifically, as FIG. 2A illustrates, the joint portion J closer to the first end 11a of the conductive wire L may be positioned in the fourth quadrant R4, and the joint portion J closer to the second end 11b of the conductive wire L may be positioned in the second quadrant R2. Instead of the embodiment in FIG. 2A, as FIG. 2B illustrates, more than half the area of one of the joint portion J may be disposed in a quadrant not adjacent to the quadrant in which more than half the area of the other joint portion J is disposed.

When the arrangement of the joint portions J is specified in a different point of view, regarding the joint portions J, an imaginary straight line A (refer to FIG. 2A) connecting the paired joint portions J to one another may form an acute angle (refer to an angle α in FIG. 2A) with an outer surface, of the body 1, at which the metal terminal 30 is exposed when viewed in the winding axis direction of the conductive wire L. In other words, the angle formed by the imaginary straight line A with the outer surface, of the body 1, at which the metal terminal 30 is exposed is not right angle (90°). Here, “the imaginary straight line connecting the joint portions to one another” means the imaginary straight line A (refer to FIG. 2A) connecting any points positioned within a joint region that is one of the joint portions J to any points positioned within a joint region that is the other joint portion J. That is, any points for drawing the imaginary straight line A may be selected in any manner as long as such points are positioned within the above-described joint regions. Thus, when the coil component of the present disclosure is manufactured, the winding portion 10 can be suppressed from tilting compared with the coil component in FIG. 11A representing the related art.

When the arrangement of the joint portions J is specified in a further different point of view, the joint portions J may be provided on a diagonal line on an imaginary plane extending thorough the winding axis W. In the specification, “the imaginary plane extending thorough the winding axis W” means a plane imaginarily existing inside the body 1. FIGS. 2A and 3 illustrate an embodiment in which an imaginary plane on which the joint portions J are arranged is substantially perpendicular (90°) to the winding axis W, and the winding axis W extends therethrough. However, the illustrated example is not the only option, and the winding axis W may extend through the imaginary plane with the imaginary plane being inclined to the winding axis W at a predetermined angle. Even when there is such a relationship in which the imaginary plane on which the joint portions J are arranged and the winding axis W are inclined to one another at a predetermined angle, the winding portion 10 can be suppressed from tilting compared with the coil component in FIGS. 11A and 11B representing the related art.

The inside portion 31 of the metal terminal 30 may have an outer edge curved according to the curved shape of the winding portion 10 (refer to FIG. 1). Thus, a separation distance between the inside portion 31 and the winding portion 10 may be maintained uniform. With such a uniform separation distance, a withstand voltage can be improved.

The outside portion 32 of the metal terminal 30 may be exposed outside the body 1. The outside portion 32 may be bent so as to extend along a side surface and a lower surface of the body 1. In other words, the outside portion 32 of the metal terminal 30 may be provided from the side surface to the lower surface of the body 1.

A portion of the metal terminal 30 may be extended outside an outer surface of the body parallel to the winding axis W. More specifically, the metal terminals 30 may be exposed at two side surfaces of the body 1 that face one another. Such arrangement enables the metal terminals 30 to be as far apart from one another as possible, and the metal terminals 30 can thereby be prevented from becoming shorted one another. Note that, the metal terminals 30 may be exposed at two side surfaces of the body 1 that are orthogonal to one another as long as the imaginary straight line A connecting the paired joint portions J to one another forms an acute angle with an outer surface of the body 1 at which the metal terminal 30 is exposed.

The outside portion 32 may be mounted on, for example, a substrate S, at a position below the lower surface of the body 1 (refer to FIG. 3). Such mounting may be performed with, for example, a solder H or a conductive adhesive. Because the coil component C of the present disclosure is mounted on the substrate S by using the metal terminals 30, even when external force is applied and bends the substrate S, the metal terminals 30 are bent according to such bending. That is, an influence of such bending on the substrate S can be reduced.

Description of Manufacturing Method of Coil Component

Next, a manufacturing method of the coil component of the present disclosure will be described. The manufacturing method of the coil component of the present disclosure includes the following steps: a step of winding conductive wire, a step of aligning height positions of first end and second end of conductive wire, a step of electrically joining metal terminals to first end and second end of conductive wire, a step of forming body by covering, with magnetic body portion, winding portion formed by winding conductive wire, and a step of bending metal terminal along body.

Hereinafter, each of the steps will be described.

Step of Winding Conductive Wire

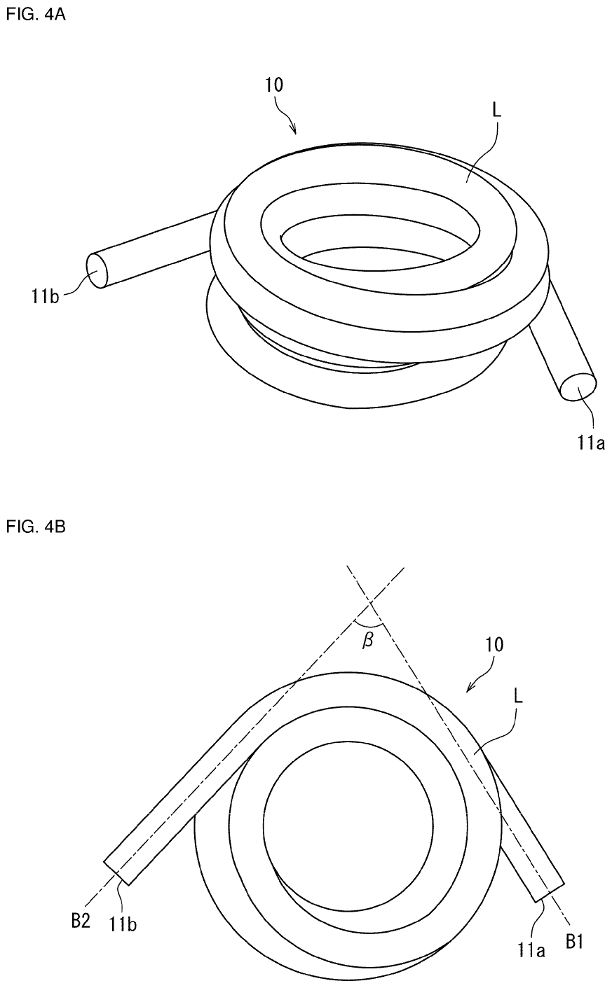

First, the conductive wire L is prepared. In one example, a metal wire (for example, a copper wire) having an insulating coating on the surface thereof is wound (refer to FIGS. 4A and 4B). Examples of the winding method of the conductive wire L are given in FIGS. 5A and 5B.

The winding method given in FIG. 5A is as follows. A winding start is positioned on the inner side, the conductive wire is wound downward around the winding axis from 1 to 4 in FIG. 5A, the conductive wire is then wound upward around the winding axis from 4 to 7, and a winding finish is positioned on the outer side of the winding portion. When the conductive wire is wound as described above, a portion of the conductive wire extended on the winding start side protrudes from the winding portion 10 in the winding axis direction. Thus, in “the step of aligning height positions of first end and second end of conductive wire”, which will be described later, more adjustments are required for the heights of a portion of the conductive wire extended on the winding start side and a portion of the conductive wire extended on the winding finish side.

On the other hand, the winding method given in FIG. 5B is as follows. A winding start is positioned on the outer side, the conductive wire is wound upward around the winding axis from 1 to 2 in FIG. 5B, the conductive wire is then wound downward around the winding axis from 2 to 5, the conductive wire is then again wound upward around the winding axis from 5 to 7, and a winding finish is positioned on the outer side of the winding portion. When the conductive wire is wound as described above, a portion of the conductive wire L extended on the winding start side and a portion of the conductive wire extended on the winding finish side can be suppressed from protruding from the winding portion 10 in the winding axis direction. Thus, in “the step of aligning height positions of first end and second end of conductive wire”, which will be described later, the height positions can be aligned more easily.

The conductive wire L is wound so that, in plan view in the winding axis direction, the angle θ is formed by the imaginary straight line B1 (refer to FIG. 4B) connecting the extended portion extended outside the winding portion 10 to the first end 11a of the conductive wire L with the imaginary straight line B2 (refer to FIG. 4B) connecting the extended portion extended outside the winding portion 10 to the second end 11b of the conductive wire L is an acute angle. The range of the acute angle of 70° or more and less than 90° (i.e., from 70° to less than 90°) is preferable. Within such a range, the winding portion 10 can be suppressed from tilting in “the step of forming body”, which will be described later.

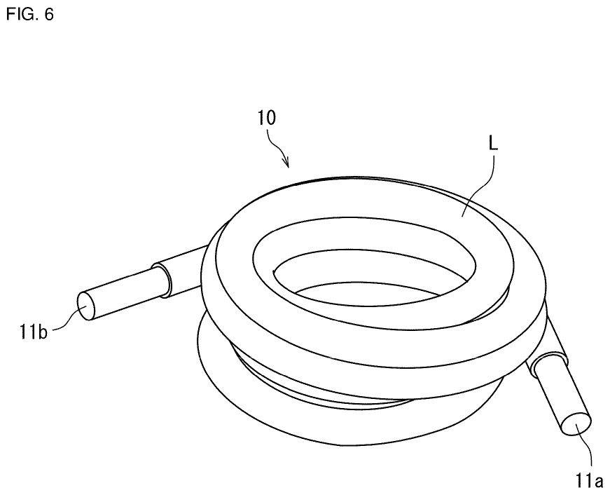

Next, as FIG. 6 illustrates, the insulating coating of each of the first end 11a and the second end 11b of the conductive wire is removed by, for example, laser irradiation. Thus, the metal of each of the first end 11a and the second end 11b of the conductive wire L becomes exposed, and electrical joining can thereby be performed.

Step of Aligning Height Positions of First End and Second End of Conductive Wire

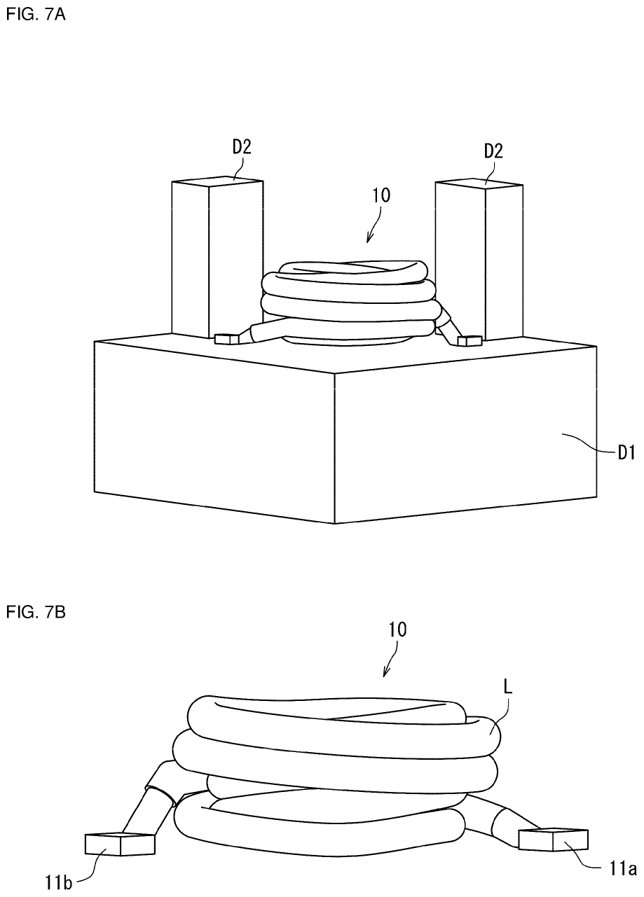

As FIG. 7A illustrates, the wound conductive wire L is disposed on a base D1, and each of the first end 11a and the second end 11b of the conductive wire L is pressed by a pressing device D2 from above. Due to such pressing, the first end 11a and the second end 11b of the conductive wire L can be aligned at substantially the same height (refer to FIG. 7B). In other words, the second end 11b of the conductive wire L can be disposed on an extension line of the first end 11a of the conductive wire L. Further, the lower surface of the winding portion 10 and the first end 11a and the second end 11b of the conductive wire L may be aligned at substantially the same height.

In addition, each of the first end 11a and the second end 11b of the conductive wire L is pressed, by the pressing device D2, into a flat shape. In the specification, “the flat shape” means a shape formed by pressing a non-target object to have an upper and/or lower flat face. Specifically, the first end 11a and the second end 11b of the conductive wire L are preferably flattened to a thickness equal to two-thirds or less of the diameter of the conductive wire L. Thus, the contact area with the metal terminal 30 can be increased, and the first end 11a or the second end 11b of the conductive wire L and the paired metal terminals 30 can thereby be joined to one another firmly.

Step of Electrically Joining Metal Terminals to First End and Second End of Conductive Wire

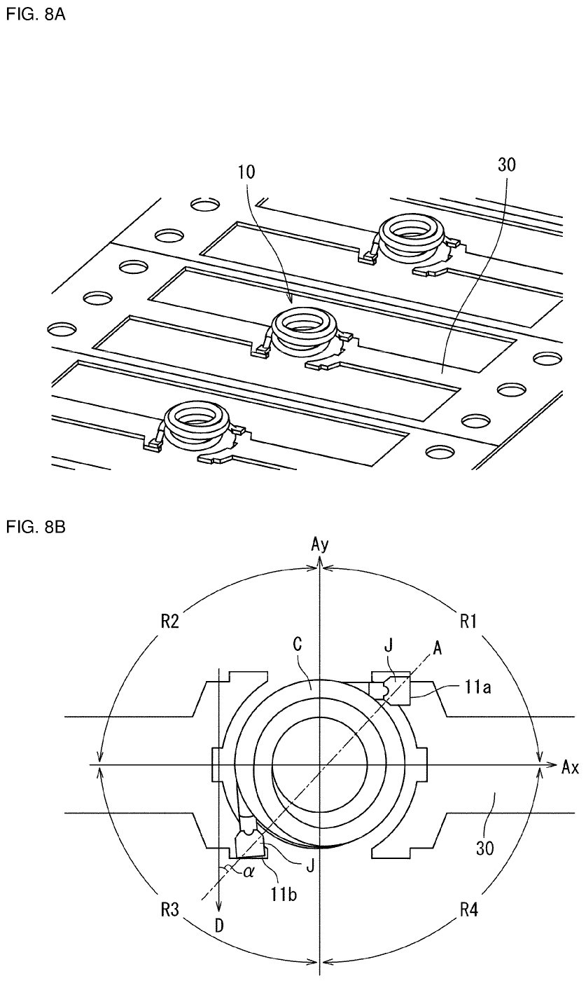

First, the metal terminals 30 having a plate shape are prepared. The first end 11a and the second end 11b of the conductive wire L are electrically joined to the metal terminals 30 of a metal plate (refer to FIGS. 8A and 8B). Such electrical joining is performed with laser welding, with the metal terminals 30 being in contact with the first end 11a and the second end 11b of the conductive wire L. The heights of the first end 11a and the second end 11b of the wound conductive wire L have been aligned in the above-described step, and the conductive wire L and the metal terminals 30 can thereby be easily joined to one another. In addition, because a portion of the conductive wire L that has been extended from the lowermost tier (or the uppermost tier) is subjected to, for example, laser welding, an influence of the laser on the lowermost tier (or the uppermost tier) of the conductive wire L can be reduced. Note that the joining method is not limited to this example, and joining may be performed with, for example, a conductive adhesive. Accordingly, the first end 11a and the second end 11b of the conductive wire L and the metal terminals 30 are electrically connected to one another.

Here, regarding the joint portions J of the metal terminals 30, more than half the plane area of one of the joint portions J may be disposed in a quadrant not adjacent to the quadrant in which more than half the plane area of the other joint portion J is disposed. Specifically, the joint portion J closer to the first end 11a of the conductive wire may be positioned in the first quadrant R1, and the joint portion J closer to the second end 11b of the conductive wire may be positioned in the third quadrant R3. When the arrangement of the joint portions J is specified in a different point of view, the imaginary straight line A connecting the paired joint portions J to one another forms an acute angle (angle α) with a line D (refer to FIG. 8B) orthogonal to a direction in which the metal terminal extends. That is, the angle formed by the imaginary straight line A with the line D is less than 90°. Within such a range, the winding portion 10 can be suppressed from tilting in “the step of forming body”, which will be described later.

Step of Forming Body by Covering, with Magnetic Body Portion, Winding Portion Formed by Winding Conductive Wire

First, a mold for forming the body will be described.

Description of Mold

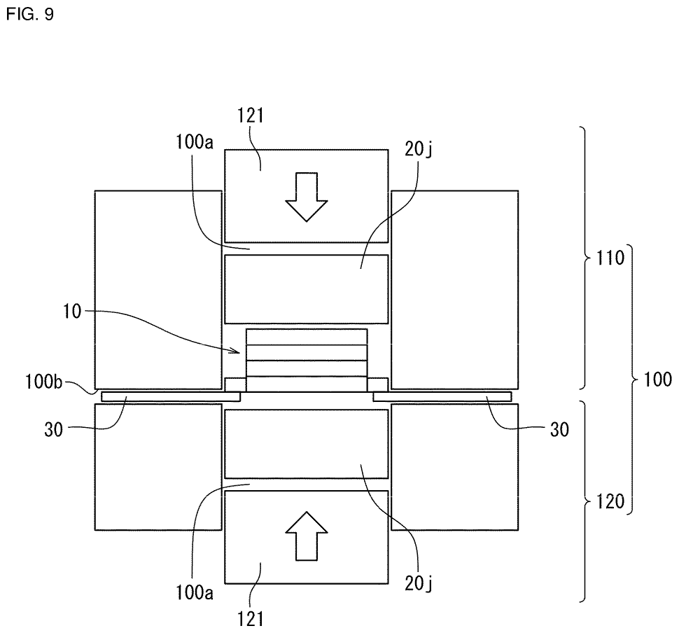

As FIG. 9 illustrates, a mold 100 may include an upper mold 110 and a lower mold 120. The upper mold 110 and the lower mold 120 are moved so as to approach relative to one another and perform mold clamping.

The mold 100 may have a storage portion 100a for storing a magnetic material 20j used for forming the magnetic body portion 20 and a sandwiching portion 100b that sandwiches the metal terminal 30. More specifically, the storage portion 100a and the sandwiching portion 100b may be disposed between the upper mold 110 and the lower mold 120.

The mold 100 may include a magnetic material supply portion 121 (refer to FIG. 9) that supplies a magnetic material toward the wound conductive wire (the winding portion 10). The magnetic material supply portion 121 is moved so as to supply the magnetic material stored in the mold 100. Note that the magnetic material supply portion 121 may be provided in each of or any one of the upper mold and the lower mold.

Description of Step of Forming Body

The step of forming the body 1 with the above-described mold 100 will be described. The magnetic material 20j is stored in each of the upper mold 110 and the lower mold 120. Here, the magnetic material 20j to be stored in each of the upper mold and the lower mold may be pressurized under a pressure of about 1 t/cm² or more and 10 t/cm² or less (i.e., from 1 t/cm² to 10 t/cm²) for a period of from several seconds to several minutes in one example. Such a magnetic material pressed together by being pressurized as described above can be easily handled when being stored in the mold.

The magnetic material 20j is stored in each of the upper mold 110 and the lower mold 120, and the winding portion 10 to which the metal terminals 30 are connected is also disposed between the upper mold 110 and the lower mold 120. Subsequently, the upper mold 110 and the lower mold 120 are clamped. The magnetic material supply portion 121 is then moved toward the winding portion 10, and the magnetic material 20j covers the winding portion 10.

Here, as described above, in the manufacturing method of the present disclosure, more than half the plane area of one of the joint portions J may be disposed in a quadrant not adjacent to the quadrant in which more than half the plane area of the other joint portion J is disposed. Thus, the stress that tilts the winding portion 10 can be reduced compared with the coil component of the related art. In addition, the stress can be applied to the winding portion 10 uniformly because the heights of the first end 11a and the second end 11b of the conductive wire L are aligned. Thus, the tilt of the winding portion 10 can be reduced.

After the magnetic material 20j has covered the winding portion 10, the mold 100 is heated to cure the magnetic material. Note that, in this curing, the magnetic material 20j may be semi-cured to a hardness with which the shape thereof is maintained in the mold 100 and may be perfectly cured in another step. Subsequently, the mold 100 is opened, and a molded item is removed. An extra portion of the metal terminals is, for example, trimmed away, and the molded item is thus shaped.

Step of Bending Metal Terminal Along Body

After the body is shaped, the metal terminal 30 is bent along a side surface and the mounting surface of the body 1. Due to this bending, the coil component C that is mountable by using the metal terminals 30 can be manufactured.

Note that the embodiments disclosed herein are illustrative in all respects and do not constitute grounds for limitative interpretation. Thus, the technical scope of the present disclosure is not interpreted according to only the above-described embodiments but is defined based on the statements of the claims. In addition, the technical scope of the present disclosure includes all modifications within the meaning and scope equivalent to the claims.

Aspects of the coil component of the present disclosure are as follows.

<1> A coil component includes a body having a substantially hexahedral shape and including a winding portion formed by winding a conductive wire based on a winding axis and a magnetic body portion; and paired metal terminals having joint portions to which a first end and a second end of the conductive wire are electrically connected. Each of the paired metal terminals is extended outside an outer surface of the body parallel to the winding axis. Also, of four quadrants separated from one another by imaginary coordinate axes that are orthogonal to one another with a center of the body as an origin in plan view in the winding axis direction, more than half an area of one of the joint portions is disposed in a quadrant not adjacent to a quadrant in which more than half an area of the other joint portion is disposed. In addition, a height difference between the joint portion closer to the first end and the joint portion closer to the second end is less than or equal to a diameter of the conductive wire.

<2> The coil component according to <1>, in which the winding axis is positioned so as to extend through a substantial center of the body.

<3> The coil component according to <1> or <2>, in which the joint portions are provided on a diagonal line on an imaginary plane extending through the winding axis.

<4> The coil component according to any one of <1> to <3>, in which the conductive wire is wound around the winding axis direction in several turns, and a height difference between the joint portion closer to the first end or the joint portion closer to the second end and an upper surface of an uppermost tier or a lower surface of a lowermost tier of the winding portion is less than or equal to the diameter of the conductive wire.

<5> The coil component according to any one of <1> to <4>, in which an end portion of the conductive wire electrically connected to the joint portion is flattened to a thickness equal to two-thirds or less of the diameter of the conductive wire.

<6> The coil component according to any one of <1> to <5>, in which the winding axis is positioned at a substantial center of the body, and an angle formed by an imaginary straight line from a portion of the conductive wire extended outside the winding portion to the first end of the conductive wire with an imaginary straight line from a portion of the conductive wire extended outside the winding portion to the second end of the conductive wire is an acute angle.

<7> The coil component according to any one of <1> to <6>, in which the magnetic body portion contains a magnetic metal particle and a resin.

<8> The coil component according to any one of <1> to <7>, in which a portion of the conductive wire is extended from an uppermost tier or a lowermost tier of the winding portion toward a corresponding one of the joint portions.

<9> The coil component according to any one of <1> to <8>, in which a winding start and a winding finish of the conductive wire are positioned on an outermost side of the winding portion.

<10> The coil component according to any one of <1> to <9>, in which an entirety of each of the joint portions is positioned inside the body.

In the present disclosure, the coil component can preferably serve as an electronic component with which variation in magnetic characteristics can be improved.

What is claimed is:

1. A coil component comprising:
a body having a substantially hexahedral shape, the body including a winding portion including a conductive wire wound on a winding axis and a magnetic body portion; and
paired metal terminals having joint portions to which a first end and a second end of the conductive wire are electrically connected, wherein
each of the paired metal terminals is extended outside an outer surface of the body parallel to the winding axis,
of four quadrants separated from one another by imaginary coordinate axes that are orthogonal to one another with a center of the body as an origin in plan view in the winding axis direction, more than half an area of one of the joint portions is disposed in a quadrant not adjacent to a quadrant in which more than half an area of the other joint portion is disposed, and
a height difference between the joint portion closer to the first end and the joint portion closer to the second end is less than or equal to a diameter of the conductive wire.

2. The coil component according to claim 1, wherein
the winding axis extends through a substantial center of the body.

3. The coil component according to claim 1, wherein
the joint portions are on a diagonal line on an imaginary plane extending through the winding axis.

4. The coil component according to claim 1, wherein
the conductive wire is wound around the winding axis direction in several turns, and
a height difference between the joint portion closer to the first end or the joint portion closer to the second end and an upper surface of an uppermost tier or a lower surface of a lowermost tier of the winding portion is less than or equal to the diameter of the conductive wire.

5. The coil component according to claim 1, wherein
an end portion of the conductive wire electrically connected to the joint portion is flattened to a thickness equal to two-thirds or less of the diameter of the conductive wire.

6. The coil component according to claim 1, wherein
the winding axis is at a substantial center of the body, and an angle defined by an imaginary straight line from a portion of the conductive wire extended outside the winding portion to the first end of the conductive wire with an imaginary straight line from a portion of the conductive wire extended outside the winding portion to the second end of the conductive wire is an acute angle.

7. The coil component according to claim 1, wherein
the magnetic body portion contains a magnetic metal particle and a resin.

8. The coil component according to claim 1, wherein
a portion of the conductive wire extends from an uppermost tier or a lowermost tier of the winding portion toward a corresponding one of the joint portions.

9. The coil component according to claim 1, wherein
a winding start and a winding finish of the conductive wire are on an outermost side of the winding portion.

10. The coil component according to claim 1, wherein
an entirety of each of the joint portions is inside the body.
